(19) United States
(12) Patent Application Publication
(10) Pub. No.: US 2025/0128589 A1
(43) Pub. Date: Apr. 24, 2025

(54) ROLL ROD FOR VEHICLE

(71) Applicants: Hyundai Motor Company, Seoul (KR); Kia Corporation, Seoul (KR)

(72) Inventors: Jae Hyung Yun, Ansan-si (KR); Young Deuk Seo, Changwon-si (KR); Hyoung Jin Yoon, Suwon-si (KR); Gu Gyun Kwon, Seoul (KR)

(21) Appl. No.: 18/762,819

(22) Filed: Jul. 3, 2024

(30) Foreign Application Priority Data
Oct. 19, 2023 (KR) 10-2023-0140529

(51) Int. Cl. B60K 5/12

(52) U.S. Cl. CPC B60K 5/1283

(57) ABSTRACT

An embodiment roll rod includes a rod bracket, a front insulator coupled to a front portion of the rod bracket, an end plate including a fastening bar press-fitted and fixed into a rear portion of the rod bracket, a rear insulator coupled to the fastening bar and disposed between the end plate and the rod bracket, and a casing bracket coupled to an outer portion of the rear insulator.

### CROSS-REFERENCE TO RELATED APPLICATIONS

This application claims the benefit of Korean Patent Application No. 10-2023-0140529, filed on Oct. 19, 2023, which application is hereby incorporated herein by reference.

### TECHNICAL FIELD

The present disclosure relates to a roll rod for a vehicle.

### BACKGROUND

In general, as one of the mounting elements for supporting a powertrain of a vehicle, a roll rod, which connects the powertrain to a vehicle body, is used. The roll rod is connected between the powertrain and the vehicle body and serves to control a roll motion of the powertrain and isolate vibration.

Components, which constitute the roll rod, are exposed to a load in various conditions, and various studies are being conducted on methods of assembling the roll rod.

Among the methods of assembling the roll rod, an assembling method using a bolt and a nut is advantageous in structurally, comparatively easily, and securely assembling the roll rod. However, there is a problem in that the number of components and the number of operators are increased, which inevitably increases costs and weight. In addition, the assembling structure using the bolt and the nut has an unexpected problem in that the bolt is loosened from the nut because of a particular load and resonance under repeated conditions.

FIG. 6 attached hereto is a view illustrating a roll rod for a vehicle in the related art.

As illustrated in FIG. 6, a roll rod in the related art includes a rod bracket 1 disposed between a powertrain and a vehicle body, and front and rear insulators 2 and 3 are provided at two opposite ends of the rod bracket 1.

The front insulator 2 is connected to the powertrain, and the rear insulator 3 is connected to the vehicle body through a casing bracket 4. In addition, the rear insulator 3 is assembled between an end plate 5 and the rod bracket 1 by a bolt 6 and a nut 7 in a state in which the rear insulator 3 is compressed.

The rear insulator 3 press-fitted into the casing bracket 4 is compressed and temporarily assembled to the rod bracket 1 by means of the end plate 5, and then the bolt 6 and the nut 7 are assembled to fix the rear insulator 3 in a compressed state. For this reason, the roll rod in the related art is difficult to assemble in an automatic assembling line. Therefore, a separate operator performs the temporary assembling process on the roll rod before assembling the bolt 6 and the nut 7.

In addition, because the roll rod in the related art uses the bolt 6 and the nut 7, there is a disadvantage in terms of costs and weight, and there is a need for a separate configuration for preventing the bolt 6 from being loosened by a load.

The above information disclosed in this background section is only for enhancement of understanding of the background of embodiments of the invention, and therefore it may contain information that does not form the prior art that is already publicly known.

### SUMMARY

The present disclosure relates to a roll rod for a vehicle. Particular embodiments relate to a roll rod for a vehicle that may be manufactured with a reduced weight at a lower cost and automatically assembled to improve productivity in comparison with the related art.

Embodiments of the present disclosure can solve problems in the art, and an embodiment of the present disclosure provides a roll rod for a vehicle that has a new assembling structure for solving problems caused by an assembling structure of a roll rod in the related art, thereby reducing costs and weight and improving productivity by implementing automatic assembling in comparison with the related art.

The embodiments of the present disclosure are not limited to the aforementioned embodiments, and other embodiments of the present disclosure, which are not mentioned above, will be clearly understood by those skilled in the art from the following description.

An embodiment of the present disclosure provides a roll rod for a vehicle having has a front insulator connected to a powertrain. The roll rod includes a rod bracket having a front portion to which the front insulator is assembled, an end plate having a fastening bar press-fitted and fixed into a rear portion of the rod bracket, a rear insulator assembled to the fastening bar and disposed between the end plate and the rod bracket, and a casing bracket assembled to an outer portion of the rear insulator and fastened to a vehicle body.

According to an embodiment of the present disclosure, a fastening hole portion may be provided in the rear portion of the rod bracket, and a front portion of the fastening bar may be press-fitted into the fastening hole portion.

In addition, the front portion of the fastening bar may have an outer diameter equal to or smaller than an inner diameter of the fastening hole portion.

According to an embodiment of the present disclosure, a plurality of anti-rotation protrusions may be provided on the front portion of the fastening bar, a plurality of protrusion insertion grooves may be provided in an inner surface of the fastening hole portion, and the plurality of anti-rotation protrusions may be assembled to the plurality of protrusion insertion grooves.

The plurality of anti-rotation protrusions may extend in a length direction of the fastening bar and be arranged in a circumferential direction of the fastening bar.

In addition, a rivet portion may be provided on the front portion of the fastening bar and disposed forward of the anti-rotation protrusions. The rivet portion may be adhered to a front end of the fastening hole portion while being pressed by a riveting jig, which is positioned forward of the fastening hole portion, when the anti-rotation protrusions are inserted into the protrusion insertion grooves.

In addition, the rivet portion may have an outer diameter larger than an inner diameter of the fastening hole portion when the rivet portion is adhered to the front end of the fastening hole portion.

In addition, the fastening bar may be structured to protrude from one surface of the end plate.

The roll rod of embodiments of the present disclosure provide the following effects through the above-mentioned solutions.

First, according to the roll rod of embodiments of the present disclosure, the end plate is fixed to the rod bracket by press-fitting and riveting, such that a bolt and a nut, which have been used to assemble an end plate and a rod bracket of a roll rod in the related art, are excluded, which may reduce costs and weight.

Second, according to the roll rod of embodiments of the present disclosure, the end plate is fixed to the rod bracket by press-fitting and riveting, such that the roll rod may be assembled in the automatic assembling line for the vehicle, thereby improving productivity and reducing costs.

Third, according to the roll rod of embodiments of the present disclosure, the end plate is fixed to the rod bracket by press-fitting and riveting, such that it is not necessary to provide a separate configuration for preventing a bolt, which has been used to assemble an end plate and a rod bracket in the related art, from being loosened.

The effects of embodiments of the present disclosure are not limited to the aforementioned effects, and other effects of embodiments of the present disclosure, which are not mentioned above, will be clearly understood by those skilled in the art from the following description.

Other aspects and embodiments of the invention are discussed infra.

It is understood that the term “vehicle” or “vehicular” or other similar term as used herein is inclusive of motor vehicles in general such as passenger automobiles including sports utility vehicles (SUVs), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of embodiments of the invention are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the embodiments of the present disclosure, and wherein:

FIGS. 1 and 2A are top plan views illustrating assembled states of a roll rod for a vehicle according to an embodiment of the present disclosure;

FIG. 2B is a side view illustrating an assembled state of the roll rod for a vehicle according to the embodiment of the present disclosure;

FIG. 3 is a view illustrating a disassembled state of the roll rod for a vehicle according to an embodiment of the present disclosure;

FIG. 4 is a perspective view illustrating a rod bracket of the roll rod for a vehicle according to an embodiment of the present disclosure;

FIGS. 5A and 5B are schematic views illustrating a process of assembling the roll rod for a vehicle according to an embodiment of the present disclosure; and

FIG. 6 is a view illustrating a roll rod for a vehicle in the related art.

It should be understood that the appended drawings are not necessarily to scale, presenting a somewhat simplified representation of various features illustrative of the basic principles of embodiments of the invention. The specific design features of embodiments of the present disclosure as disclosed herein, including, for example, specific dimensions, orientations, locations, and shapes will be determined in part by the particular intended application and use environment.

In the figures, reference numbers refer to the same or equivalent parts of the embodiments of the present disclosure throughout the several figures of the drawings.

### DETAILED DESCRIPTION OF ILLUSTRATIVE EMBODIMENTS

Hereinafter reference will now be made in detail to various embodiments of the present disclosure, examples of which are illustrated in the accompanying drawings and described below. While embodiments of the invention will be described in conjunction with exemplary embodiments, it will be understood that the present description is not intended to limit the embodiments of the invention to those exemplary embodiments. On the contrary, the embodiments of the invention are intended to cover not only the exemplary embodiments, but also various alternatives, modifications, equivalents, and other embodiments, which may be included within the spirit and scope of the embodiments of the invention as defined by the appended claims.

Hereinafter, embodiments of the present disclosure will be described with reference to the accompanying drawings. The configurations illustrated in the accompanying drawings are in a schematic form for easily explaining the embodiments of the present disclosure, but it may differ from the configurations actually implemented.

In addition, in the present specification, the terms “front-rear” and “left-right”, which indicate directions, are set based on a vehicle unless otherwise separately stated.

A roll rod for a vehicle according to embodiments of the present disclosure serves to support a powertrain by being used together with an engine mount that is installed between an engine and a vehicle body and a transmission mount that is installed between a transmission and the vehicle body. The roll rod is connected between the powertrain and the vehicle body and serves to control a roll motion of the powertrain and isolate vibration noise.

In particular, the roll rod according to embodiments of the present disclosure has a structure that excludes a bolt and a nut in order to improve an assembling structure of a roll rod in the related art. Specifically, the roll rod according to embodiments of the present disclosure is configured such that an end plate and a rod bracket are integrally coupled and fixed without separate fastening components such as a bolt and a nut.

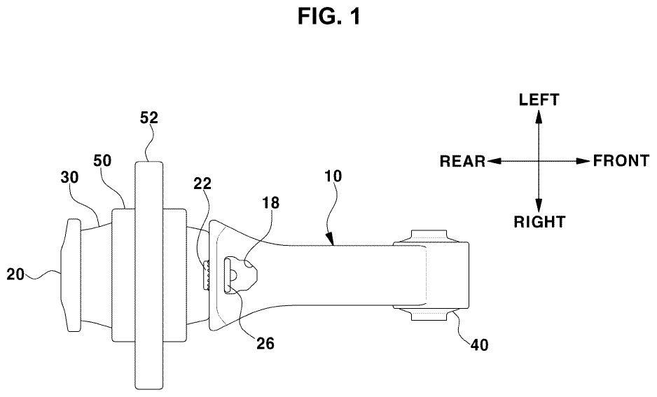

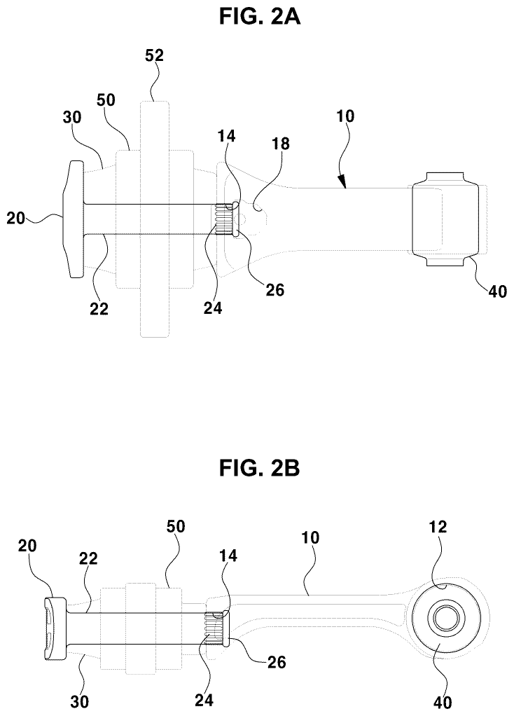

As illustrated in FIGS. 1 to 3, the roll rod for a vehicle according to an embodiment of the present disclosure includes a rod bracket 10, an end plate 20, a rear insulator 30, and a front insulator 40.

The rod bracket 10 is elongated in a forward/rearward direction of the vehicle and is connected between the powertrain and the vehicle body. The front insulator 40, which is coupled to the powertrain, is mounted on a front portion of the rod bracket 10, and the rear insulator 30 and the end plate 20 are coupled to a rear portion of the rod bracket 10.

That is, the rod bracket 10 has the front portion to which the front insulator 40 is assembled and the rear portion on which the rear insulator 30 and the end plate 20 are mounted.

A front mounting portion 12 is provided on the front portion of the rod bracket 10, and the front insulator 40 is press-fitted and mounted into the front mounting portion 12. The front insulator 40 may be press-fitted into the front mounting portion 12 in a leftward/rightward direction of the vehicle.

With reference to FIG. 4, a fastening hole portion 14 is provided in the rear portion of the rod bracket 10 and serves to couple and fix the end plate 20. The fastening hole portion 14 has a hole structure into which a fastening bar 22 of the end plate 20 is press-fitted.

The rod bracket 10 may be connected between the powertrain and the vehicle body and may absorb vibration of the powertrain while moving in the forward/rearward direction of the vehicle in accordance with a motion of the powertrain.

The fastening bar 22 is integrated with the end plate 20 and press-fitted and fixed into the fastening hole portion 14 of the rod bracket 10. The fastening bar 22 is structured to protrude from one surface of the end plate 20, and a front portion of the fastening bar 22 is press-fitted and fixed into the fastening hole portion 14.

In other words, the fastening bar 22 has the front portion press-fitted into the fastening hole portion 14 of the rod bracket 10 and a rear portion protruding from one surface of the end plate 20. The fastening bar 22 extends in the forward/rearward direction of the vehicle and a length direction of the rod bracket 10. The front portion of the fastening bar 22 may have an outer diameter equal to or smaller than an inner diameter of the fastening hole portion 14 so that the front portion of the fastening bar 22 is press-fitted into the fastening hole portion 14.

In addition, a plurality of anti-rotation protrusions 24 is provided on the front portion of the fastening bar 22. The plurality of anti-rotation protrusions 24 protrudes from an outer peripheral surface of the front portion of the fastening bar 22 and extends in a length direction of the fastening bar 22. The plurality of anti-rotation protrusions 24 is arranged to be spaced apart from one another in a circumferential direction of the fastening bar 22. That is, the anti-rotation protrusions 24, which define a spline structure, are provided on the front portion of the fastening bar 22.

Further, a plurality of protrusion insertion grooves 16 is provided in an inner surface of the fastening hole portion 14 of the rod bracket 10, and the plurality of anti-rotation protrusions 24 is assembled and fixed to the plurality of protrusion insertion grooves 16. The anti-rotation protrusions 24 are inserted into the protrusion insertion grooves 16 in the length direction of the fastening bar 22 when the front portion of the fastening bar 22 is press-fitted into the fastening hole portion 14.

The plurality of protrusion insertion grooves 16 extends in the length direction of the anti-rotation protrusions 24 and the fastening bar 22 and is arranged in an arrangement direction of the anti-rotation protrusions 24 and a circumferential direction of the fastening hole portion 14.

In addition, a rivet portion 26 is provided on the front portion of the fastening bar 22. The rivet portion 26 is disposed forward of the anti-rotation protrusions 24.

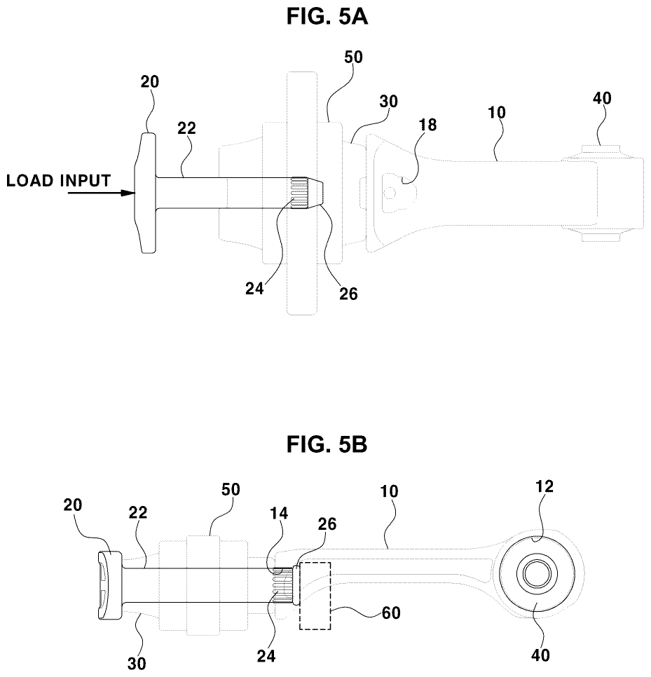

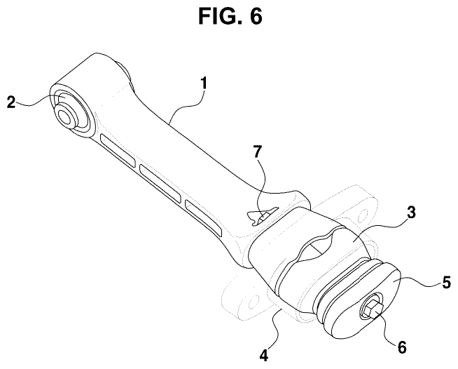

FIGS. 5A and 5B are views schematically illustrating a process of assembling the roll rod according to an embodiment of the present disclosure.

With reference to FIGS. 5A and 5B, the rivet portion 26 penetrates the fastening hole portion 14 and protrudes forward from the fastening hole portion 14 when the anti-rotation protrusions 24 are inserted into the protrusion insertion grooves 16. In this case, the rivet portion 26 is adhered to a front end of the fastening hole portion 14 while being pressed and deformed by a riveting jig 60.

Specifically, in a state in which the rear insulator 30 and the rod bracket 10 are supported so as not to move, the fastening bar 22 of the end plate 20 is press-fitted into the fastening hole portion 14 of the rod bracket 10 while penetrating the rear insulator 30 by a pressing device. The pressing device may be provided in an automatic assembling line for the vehicle.

In this case, the end plate 20 compresses the rear insulator 30 by a load inputted by the pressing device. The rivet portion 26 of the fastening bar 22 penetrates the fastening hole portion 14 and protrudes forward from the fastening hole portion 14.

The riveting jig 60 is positioned and provided forward of the fastening hole portion 14. The rivet portion 26 protruding forward from the fastening hole portion 14 is pressed against the riveting jig 60 by a load applied by the pressing device. In this case, the rivet portion 26 is continuously pressed even after the rivet portion 26 is in contact with the riveting jig 60, and the rivet portion 26 is pressed until the anti-rotation protrusion 24 is completely inserted into the protrusion insertion groove 16.

Therefore, the rivet portion 26 is adhered to the front end of the fastening hole portion 14 while being pressed and deformed by the riveting jig 60 positioned forward of the rivet portion 26. In this case, the riveting jig 60 is positioned at a predetermined distance from the front end of the fastening hole portion 14 so that the rivet portion 26 is pressed and deformed by the riveting jig 60 while protruding forward from the fastening hole portion 14.

Because the rivet portion 26 is adhered to the front end of the fastening hole portion 14 when the anti-rotation protrusions 24 are completely inserted into the protrusion insertion grooves 16, the fastening bar 22 may be prevented from separating rearward from the rod bracket 10.

The rivet portion 26 may be fixed to the front end of the fastening hole portion 14 by a riveting process, thereby reinforcing a coupling structure between the fastening bar 22 and the rod bracket 10 that are coupled in a press-fit manner.

The rivet portion 26 is adhered to the front end of the fastening hole portion 14 while being pressed and deformed while a press-fitting process is performed to couple the fastening bar 22 and the rod bracket 10.

Therefore, the rivet portion 26 has a larger diameter and a larger cross-sectional area after the riveting process than before the riveting process, and the rivet portion 26 in this state is joined and adhered to the front end of the fastening hole portion 14. That is, the rivet portion 26 has an outer diameter larger than an inner diameter of the fastening hole portion 14 when the rivet portion 26 is adhered to the front end of the fastening hole portion 14.

Because the fastening bar 22 is press-fitted into the fastening hole portion 14, the fastening bar 22 is prevented from separating from the fastening hole portion 14. Further, the rivet portion 26 deformed by the riveting process further prevents the fastening bar 22 from separating from the fastening hole portion 14.

The front portion of the fastening bar 22 is press-fitted into the fastening hole portion 14 of the rod bracket 10 in a state in which the front portion of the fastening bar 22 is heated to a temperature at which the rivet portion 26 may be at least deformed by the riveting process.

In addition, in order to ensure a space for performing the riveting process, an opening portion 18, which is adjacent to the front end of the fastening hole portion 14, is provided in the rear portion of the rod bracket 10. The rivet portion 26 is exposed to the outside of the rod bracket 10 through the opening portion 18. The riveting jig 60 may have a structure capable of being in contact with the front end of the rivet portion 26 protruding forward from the fastening hole portion 14. The rivet portion 26 is deformed in shape, i.e., crushed, by being pressed against the riveting jig 60.

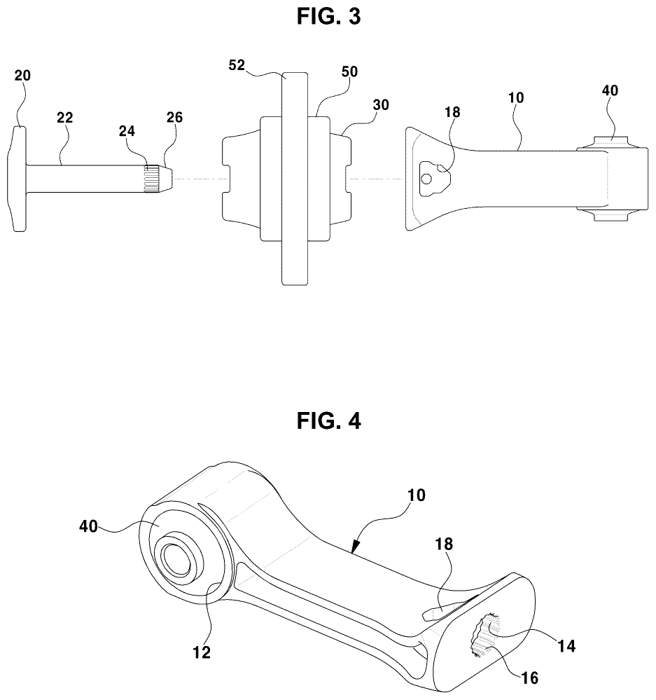

With reference to FIG. 3, the rivet portion 26 may be tapered toward the front side of the fastening bar 22. The rivet portion 26 has an outer diameter equal to or smaller than a minimum inner diameter of the fastening hole portion 14. The minimum inner diameter of the fastening hole portion 14 is an inner diameter of a portion where the protrusion insertion groove 16 is not formed.

The rear insulator 30 serves to absorb and attenuate vibration and motions of the powertrain and is made of a rubber material that provides an elastic restoring force. The rear insulator 30, together with the front insulator 40, may absorb vibration of the powertrain.

The rear insulator 30 is penetratively assembled to the fastening bar 22 of the end plate 20 and disposed between the end plate 20 and the rod bracket 10. The rear insulator 30 may be assembled in a state of being compressed between the end plate 20 and the rod bracket 10. The rear insulator 30 may be additionally compressed or restored and extended by the motion of the powertrain.

In addition, a casing bracket 50 is assembled to an outer portion of the rear insulator 30. The rear insulator 30 is press-fitted and mounted into the casing bracket 50 and connected to the vehicle body by means of the casing bracket 50.

The casing bracket 50 has vehicle body coupling portions 52 configured to be fastened to the vehicle body. The vehicle body coupling portions 52 may be respectively provided at left and right sides of the casing bracket 50.

The roll rod of embodiments of the present disclosure configured as described above may be assembled without separate fastening components such as a bolt and a nut, such that the number of components, the costs, and the weight may be reduced by excluding the bolt and the nut.

In addition, because the roll rod of embodiments of the present disclosure is assembled by press-fitting and riveting, a separate operator is not required for a temporary assembling process as in the related art, and the roll rod may be assembled in the automatic assembling line for the vehicle, thereby improving productivity and reducing costs. Further, the roll rod of embodiments of the present disclosure is prevented from being erroneously assembled by a manual process, and assembling quality is improved.

In addition, according to the roll rod of embodiments of the present disclosure, since the anti-rotation protrusions 24 of the fastening bar 22 are inserted into the protrusion insertion grooves 16 of the fastening hole portion 14, the fastening bar 22 of the end plate 20 and the fastening hole portion 14 of the rod bracket 10 may be prevented from being decoupled by a load inputted to the fastening bar 22, and the end plate 20 and the rod bracket 10 may be prevented from being erroneously assembled by bolting as in the related art.

Further, the roll rod of embodiments of the present disclosure configured as described above may be manufactured by a process including extruding the rod bracket 10 including the front portion having the front mounting portion 12 for assembling the front insulator 40, assembling the casing bracket 50, which has the vehicle body coupling portion 52 to be fastened to the vehicle body, to the outer portion of the rear insulator 30, disposing the rear insulator 30 between the rear portion of the rod bracket 10 and the end plate 20, and press-fitting and fixing the fastening bar 22 provided on the end plate 20 into the rear portion of the rod bracket 10 while allowing the fastening bar 22 to penetrate the central portion of the rear insulator 30.

The embodiments of the present disclosure have been described in detail above. The terms used in the specification and the claims should not be interpreted as being limited to a general or dictionary meaning. In addition, it should be construed that the scope of the present disclosure is not limited to the above-mentioned embodiments and many variations and modifications made by those skilled in the art using the basic concept of embodiments of the present disclosure, which is defined in the following claims, will also belong to the scope of the present disclosure.

The embodiments of the invention have been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A roll rod comprising:
a rod bracket;
a front insulator coupled to a front portion of the rod bracket;
an end plate comprising a fastening bar press-fitted and fixed into a rear portion of the rod bracket;
a rear insulator coupled to the fastening bar and disposed between the end plate and the rod bracket; and
a casing bracket coupled to an outer portion of the rear insulator.

2. The roll rod of claim 1, wherein a fastening hole portion is disposed in the rear portion of the rod bracket, and a front portion of the fastening bar is press-fitted into the fastening hole portion.

3. The roll rod of claim 2, wherein the front portion of the fastening bar has an outer diameter equal to or smaller than an inner diameter of the fastening hole portion.

4. The roll rod of claim 2, further comprising:
a plurality of anti-rotation protrusions disposed on the front portion of the fastening bar; and
a plurality of protrusion insertion grooves disposed in an inner surface of the fastening hole portion, wherein the plurality of anti-rotation protrusions is configured to be coupled to the plurality of protrusion insertion grooves.

5. The roll rod of claim 4, wherein the plurality of anti-rotation protrusions extends in a length direction of the fastening bar and is arranged in a circumferential direction of the fastening bar.

6. The roll rod of claim 4, further comprising a rivet portion disposed on the front portion of the fastening bar and disposed forward of the anti-rotation protrusions.

7. The roll rod of claim 6, wherein the rivet portion is adhered to a front end of the fastening hole portion in a state of being pressed by a riveting jig positioned forward of the fastening hole portion in a state in which the anti-rotation protrusions are inserted into the protrusion insertion grooves.

8. The roll rod of claim 7, wherein the rivet portion has an outer diameter larger than an inner diameter of the fastening hole portion in a state in which the rivet portion is adhered to the front end of the fastening hole portion.

9. A roll rod comprising:
a rod bracket;
a front insulator coupled to a front portion of the rod bracket;
an end plate comprising a fastening bar press-fitted and fixed into a rear portion of the rod bracket, wherein the fastening bar protrudes from a surface of the end plate;
a rear insulator coupled to the fastening bar and disposed between the end plate and the rod bracket; and
a casing bracket coupled to an outer portion of the rear insulator.

10. The roll rod of claim 9, wherein:
a fastening hole portion is disposed in the rear portion of the rod bracket; and
a front portion of the fastening bar is press-fitted into the fastening hole portion and has an outer diameter equal to or smaller than an inner diameter of the fastening hole portion.

11. The roll rod of claim 10, further comprising:
a plurality of anti-rotation protrusions disposed on the front portion of the fastening bar, extending in a length direction of the fastening bar, and arranged in a circumferential direction of the fastening bar;
a plurality of protrusion insertion grooves disposed in an inner surface of the fastening hole portion, wherein the plurality of anti-rotation protrusions is configured to be coupled to the plurality of protrusion insertion grooves; and
a rivet portion disposed on the front portion of the fastening bar and disposed forward of the anti-rotation protrusions.

12. The roll rod of claim 11, wherein the rivet portion is adhered to a front end of the fastening hole portion in a state of being pressed by a riveting jig positioned forward of the fastening hole portion in a state in which the anti-rotation protrusions are inserted into the protrusion insertion grooves, and wherein the rivet portion has an outer diameter larger than an inner diameter of the fastening hole portion in a state in which the rivet portion is adhered to the front end of the fastening hole portion.

13. A vehicle comprising:
a vehicle body;
a powertrain; and
a roll rod coupled between the vehicle body and the powertrain, the roll rod comprising:
a rod bracket;
a front insulator coupled to a front portion of the rod bracket and coupled to the powertrain;
an end plate comprising a fastening bar press-fitted and fixed into a rear portion of the rod bracket;
a rear insulator coupled to the fastening bar and disposed between the end plate and the rod bracket; and
a casing bracket coupled to an outer portion of the rear insulator and coupled to the vehicle body.

14. The vehicle of claim 13, further comprising a fastening hole portion disposed in the rear portion of the rod bracket, wherein a front portion of the fastening bar is press-fitted into the fastening hole portion, and wherein the front portion of the fastening bar has an outer diameter equal to or smaller than an inner diameter of the fastening hole portion.

15. The vehicle of claim 14, further comprising:
a plurality of anti-rotation protrusions disposed on the front portion of the fastening bar; and
a plurality of protrusion insertion grooves disposed in an inner surface of the fastening hole portion, wherein the plurality of anti-rotation protrusions is configured to be coupled to the plurality of protrusion insertion grooves.

16. The vehicle of claim 15, wherein the plurality of anti-rotation protrusions extends in a length direction of the fastening bar and is arranged in a circumferential direction of the fastening bar.

17. The vehicle of claim 15, further comprising a rivet portion disposed on the front portion of the fastening bar and disposed forward of the anti-rotation protrusions.

18. The vehicle of claim 17, wherein the rivet portion is adhered to a front end of the fastening hole portion in a state of being pressed by a riveting jig positioned forward of the fastening hole portion in a state in which the anti-rotation protrusions are inserted into the protrusion insertion grooves.

19. The vehicle of claim 18, wherein the rivet portion has an outer diameter larger than an inner diameter of the fastening hole portion in a state in which the rivet portion is adhered to the front end of the fastening hole portion.

20. The vehicle of claim 13, wherein the fastening bar protrudes from a surface of the end plate.
